(19) United States
(12) Patent Application Publication
(10) Pub. No.: US 2016/0083646 A1
(43) Pub. Date: Mar. 24, 2016

(54) BACKLIGHT MODULE, LIQUID CRYSTAL DISPLAY DEVICE AND SURFACE MODIFICATION METHOD FOR INFRARED MATERIAL

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: JIUXIA YANG, Beijing (CN); FENG BAI, Beijing (CN); YIMING ZHAO, Beijing (CN); XIAO SUN, Beijing (CN); BING BAI, Beijing (CN)

(21) Appl. No.: 14/236,167

(22) PCT Filed: Aug. 28, 2013
(86) PCT No.: PCT/CN2013/082478

§ 371 Date: Jan. 30, 2014

(30) Foreign Application Priority Data
Apr. 28, 2013 (CN) 201310157011.6

(51) Int. Cl. C09K 11/02; F21V 8/00

(52) U.S. Cl. CPC C09K 11/02; G02B 6/0025; G02B 6/0031

(57) ABSTRACT

A backlight module, a LCD device comprising the backlight module, a surface modification method for an IR material, and a backlight module provided with a component comprising an IR material obtained via the surface modification method are disclosed. A component comprising the IR material is disposed in the backlight module.

### FIELD OF THE ART

Embodiments of the invention relate to the field of liquid crystal technologies, more particularly, to a backlight module, a Liquid Crystal Display (LCD) device, a surface modification method for an Infrared (IR) material, and a backlight module provided with a component comprising an IR material obtained via the surface modification method.

### BACKGROUND

With the rapid development of display technologies, people expect display devices to provide display effect with high definition, high contrast ratio and high brightness; moreover, there are more diverse requirements on the functions of the display devices, such as entertaining and healthy functions.

### SUMMARY

Embodiments of the invention provide a backlight module, a LCD device, a surface modification method for an IR material and a backlight module provided with a component comprising the IR material obtained via the surface modification method, so as to emit IR light when irradiated by light.

A first aspect of the invention provides a backlight module, wherein a component comprising an infrared (IR) material is disposed in the backlight module.

As an example, the component comprising the IR material is an IR layer made of the IR material.

As an example, the backlight module comprises a luminophor, a package for packaging the luminophor and a light guide plated disposed at one side of the package,

wherein the IR layer is disposed between the package and the light guide plate; and/or the IR layer is disposed on the light guide plate.

As an example, the backlight module further comprises a reflector sheet disposed below the luminophor, a diffuser sheet and a prism sheet both disposed above the light guide plate, the IR layer is disposed on one or two sides of at least one of the reflector sheet, the diffuser sheet and the prism sheet.

As an example, the backlight module comprises a brightness enhancement film (BEF), the IR layer is disposed on one or two sides of the BEF.

As an example, the prism sheet comprises an upper prism sheet and a lower prism sheet, the IR layer is disposed on one or two sides of at least one of the upper and lower prism sheets.

As an example, the component comprising the IR material comprises at least one of the following components: a reflector sheet, a luminophor, a light guide plate, a diffuser sheet, a prism sheet, a BEF, a package for the luminophor.

As an example, an IR layer made of the IR material is disposed on all or a part of the surface of one or two sides of at least one of the components.

As an example, the backlight module comprises a reflector sheet, a package for a luminophor, a light guide plate, a diffuser sheet, a prism sheet, a BEF, at least one of which is made of a component comprising the IR material.

As an example, the IR material is a mixture of one or more of biochar, tourmaline, far-infrared ceramic, jade powder, aluminum oxide, copper(II) oxide, silver(I,III) oxide and silicon carbide.

As an example, a particle size of the IR material is in the order of a nanometer to a micrometer.

As an example, the IR material is surface modified so as to emit IR light when being irradiated.

A second aspect of the invention provides a LCD device comprising the above backlight module.

A third aspect of the invention provides a surface modification method for an IR material, comprising:

nanocrystallizing the IR material to obtain nanoparticles of the IR material;

modifying surface property of the nanocrystallized nanoparticles such that the nanoparticles are compatible and have matching property with a corresponding component of a backlight module and emit IR light when being irradiated by light.

As an example, nanocrystallizing the IR material comprises grinding and dispersing the IR material to obtain a dispersion solution of the IR material with an average particle size of 1 nm to 200 nm.

As an example, modifying the surface property of the nanocrystallized nanoparticles comprises:

mixing the dispersion solution of the IR material with an organic solvent containing methyl methacrylate, styrene, maleimide and then adding an azo-initiator solution into the mixture; and

after the reaction is finished, adding a cooling organic solvent to cool and stirring until resultant is cooled, then filtering and drying the resultant to obtain the surface modified IR material.

As an example, the molar ratio between methyl methacrylate, styrene and maleimide is 1:1˜2:1˜2, the IR material weights 8˜25% of the total mixture weight; and the azo-initiator solution is added drop by drop with a weight of 1˜5% of total monomer weight.

As an example, an environmental condition for modifying the surface property of the nanocrystallized nanoparticles has a temperature of 35° C.˜60° C. and is in a nitrogen atmosphere;

a reaction time is 30 minutes to 90 minutes;

a temperature of the cooling organic solvent is 5° C. to 10° C.;

cooling is performed till room temperature;

filtering is performed for three times; and

drying is performed for 5 minutes to 20 minutes at 70° C. to 100° C.

A fourth aspect of the invention provides a backlight module, wherein a component comprising an IR material is disposed in the backlight module, the IR material is obtained using the above surface modification method.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a configuration of a backlight module in accordance with an embodiment of the invention.

### NUMERAL REFERENCES

1-reflector sheet; 2-luminophor; 3-light guide plate (LGP); 4-diffuser sheet; 5-lower prism sheet; 6-upper prism sheet; 7-IR layer.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

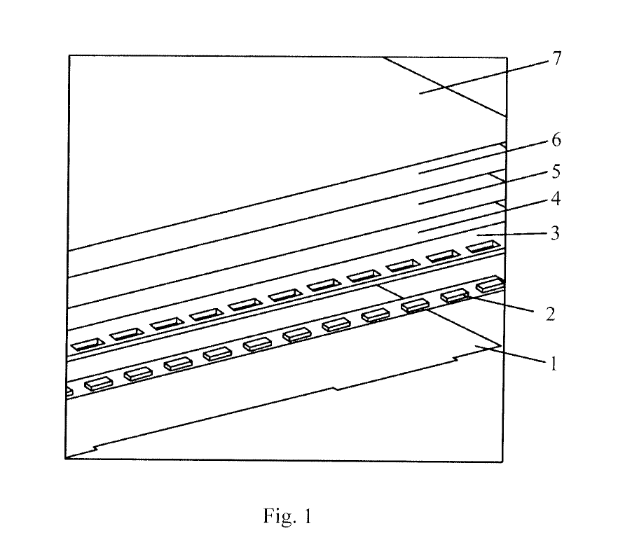

An embodiment of the invention provides a backlight module, which has a component comprising an IR material disposed therein. For example, the component comprising the IR material is an IR layer made of the IR material. It will be described in detail with reference to FIG. 1.

FIG. 1 illustrates a liquid crystal cell in accordance with an example of the invention, which comprises a reflector sheet 1, a luminophor 2, a LGP 3, a diffuser sheet 4, a lower prism sheet 5, an upper prism sheet 6, and an IR layer 7. The luminophor 2 is generally in the form of a luminophor bar, such as a LED luminophor bar. A luminophor package such as a packaging layer for packing each luminophor 2 is generally disposed at the exterior of the luminophor 2. The LGP 3 is positioned at a side of the package (e.g., on the upper side in FIG. 1). The backlight module as shown in FIG. 1 may further comprise a BEF (brightness enhancement film) and the like. The BEF is configured for enhancing the brightness of the screen and may be disposed on the upper surface of the upper prism sheet 6, such as between the upper prism sheet 6 and the IR layer 7 of FIG. 1. In the invention, the upper and lower prism sheets 5 and 6 are collectively referred to as the prism sheet. Naturally, individual components of the backlight module in real applications may be different from that shown in FIG. 1, which is for illustrative purpose only.

In the backlight module shown in FIG. 1, the IR layer 7 comprises a material that may generate IR light via heat exchange (abbreviated as IR material). The IR material can absorb energy when being irradiated so as to emit IR light with a wavelength typically of 0.77 μm˜1 mm. Moreover, the intensity of the IR light may be controlled through particle size, surface morphology and content of the available ingredient of the IR material.

The above IR material may be a mixture of one or more of biochar, tourmaline ([Na,K,Ca][Mg,F,Mn,Li,Al]₃[Al,Cr,Fe,V]₆[BO₃]₃[Si₆O₁₈][OH,F]₄), far-infrared (far-IR) ceramic, jade powder, aluminum oxide, copper(II) oxide, silver(I,III) oxide and silicon carbide. The particle size of the IR material may be for example in the order of a nanometer to a micrometer.

As shown in FIG. 1, the IR layer 7 is disposed (such as coated, the same holds in the following) on a surface of the upper prism sheet 6 that is opposite to the lower prism sheet 5 (that is, the upper side of the upper prism sheet 6). The IR layer 7 may also be disposed on a surface of the upper prism sheet 6 that faces the lower prism sheet 5 (that is, the lower side of the lower prism sheet 6). It is thus seen that the IR layer 7 may be disposed on one or two sides of the upper prism sheet 6. Similarly, the IR layer 7 may be disposed on one or two sides of the lower prism sheet 5. Therefore, the IR layer 7 may be disposed on one or two sides of the prism sheet.

In other examples of the invention, the IR layer 7 may also be disposed on one or two sides of at least one of the reflector sheet 1, the diffuser sheet 4 and the BEF. For example, the IR layer 7 may be disposed on one or two sides of the reflector sheet 1, or on one or two sides of the diffuser sheet 4, or on one or two sides of the BEF.

Other than the method of disposing the IR layer 7 on the upper prism sheet 6 as shown in FIG. 1, in other examples of the invention, the IR layer 7 may also be disposed at the exterior of the aforementioned luminophor package.

In other examples of the invention, the IR layer 7 may also be disposed on a surface of the LGP 3 that is opposite to the reflector sheet 1 (that is, the upper side of the LGP 3). The IR layer may also be disposed between the LGP 3 and the package (that is, the lower side of the LGP 3). It is thus seen that the IR layer 7 may be disposed on one or two sides of the LGP 3.

Moreover, in terms of the components of the backlight such as the reflector sheet 1, the luminophor 2, the LGP 3, the diffuser sheet 4, the lower prism sheet 5, the upper prism sheet 6, the BEF and the like, whether the IR layer 7 is disposed on one or two sides of any one or more of the components, the IR layer 7 can be coated on all or a part of the surface of the one or two sides.

Another embodiment of the invention further provides a backlight module, in which the IR material comprised in the IR layer 7 may be doped into the raw material of at least one of the components, no matter the backlight module has or has not the IR layer 7. For example, the IR material comprised in the IR layer 7 is doped into the raw material of at least one of the following components: the reflector sheet 1, the luminophor 2, the LGP 3, the diffuser sheet 4, the lower prism sheet 5, the upper prism sheet 6, the BEF, and the luminophor package.

Moreover, the IR material in the IR layer 7 may be surface modified, such that the IR material is compatible and has optimal matching property with the corresponding components of the backlight module, and the heat exchange capacity between the IR material and the backlight module as well as the environment can be improved without compromising the performance of the backlight module. The surface modified IR material emits far-IR light of a specific wavelength with a higher emissivity. The purpose of the surface modification is to modify the surface morphology, grain boundary structure of the IR material, such that the IR material can be compatible with the corresponding structure of the backlight module and not harming the performance of the backlight module. Meanwhile, a further purpose of the surface modification is to change the activity of the IR material and to improve the heat exchange capacity by modifying the surface morphology, grain boundary structure of the IR material, such that the far-IR light of a specific wavelength is emitted with higher emissivity.

Still another embodiment of the invention provides a surface modification method for an IR material, the method comprises the following steps:

1) nanocrystallizing the IR material to obtain nanoparticles of the IR material; and

2) modifying surface property of the nanocrystallized nanoparticles such that the nanoparticles are compatible and have matching property with a structural layer of a liquid crystal cell and emit IR light when being irradiated.

The purpose of step 1) is to nanocrystallize the IR material to obtain the nanoparticles of the IR material. For fabricating nanomaterial, conventional grinding and dispersion methods may be used, for example, in an organic solvent by using a conventional grinding device (such as a ball mill, a sand mill or the like) and a dispersant. A weight percentage of the IR material in the nano dispersion solution may be 10˜15%. As an example, the step 1) comprises grinding and dispersing the IR material to obtain a nano dispersion solution of the IR material with an average particle size of 1 nm to 200 nm.

The purpose of step 2) is to modify the surface property of the nanocrystallized nanoparticles such that the IR material is compatible with the structural layer of the liquid crystal cell and does not harm the performance of the display device. Meanwhile, a further purpose of the step 2) is to change the activity of the IR material and to improve the heat exchange capacity by further modifying the surface of the nanocrystallized IR material, such that the far-IR light of a specific wavelength is emitted with higher emissivity. As an example, the step 2) comprises:

mixing the dispersion solution of the IR material with an organic solution containing methyl methacrylate, styrene, maleimide, and then adding an azo-initiator solution into the mixture; and

after the reaction is finished, adding a cooling organic solvent to cool and stirring until resultant is cooled, then filtering and drying the resultant to obtain the surface modified IR material.

As another example, the step 2) comprises:

dissolving azo-initiator, such as 2,2′-Azobis-(2-methylbutyro nitrile), azobis isobutyro nitrile (AIBN), azobis isohexyl nitrile, 2,2′-Azobis isohepto nitrile or the like, in an organic solvent for further use;

placing the nano dispersion solution of the IR material in a 4-mouth flask and performing stirring, vibration (with a frequency of above 50 Hz) or shaking;

dissolving monomer including methyl methacrylate, styrene, and maleimide (the molar ratio of three monomer is 1:1˜2:1˜2/mol) in an organic solvent (with a volume ratio between the monomer and the organic solvent of 1:1˜1:3) and adding the obtained solution into the 4-mouth flask, wherein the IR material 1 weights 8˜25%, preferably 10˜20%, and more preferably 12˜17%, of the total mixture weight.

An environmental condition for modifying the surface property of the nanocrystallized nanoparticles has a temperature of 35° C.˜60° C. and in a nitrogen atmosphere; the azo-initiator solution is added drop by drop with a weight of 1˜5% of total monomer weight into the 4-mouth flask, a reaction time for stirring, vibration or shaking is 30˜90 minutes.

After the reaction is finished, adding a cooling organic solvent of 5° C. to 10° C. to cool and stirring until resultant is cooled to room temperature.

After filtering the resultant for three times, washing the filtered solid using the aforementioned organic solution with dissolved monomer, and then drying at 70° C.˜100° C. for 5˜20 minutes to obtain the surface modified IR material.

The organic solvent used in the above method may be one or more of fatty alcohol, glycol ethers, ethyl acetate, methyl ethyl ketone (MEK), 4-methylpentan-2-one, monomethyl ether acetate glycol esters, γ-butyrolactone, propionic acid-3-ether acetate, butyl carbitol, butyl carbitol acetate, propylene glycol monomethyl ether, propylene glycol monomethyl ether acetate, cyclohexane, xylene and isopropanol.

The dispersant used in the above method may be a conventional dispersant, such as BYK 410, BYK 110, BYK 163,BYK 161, BYK 2000 or the like. A weight percentage of the dispersant in the nano dispersion solution is 5˜15%, preferably 7˜12%.

A further embodiment of the invention provides a liquid crystal cell, which has a component comprising an IR material and disposed therein, the IR material is obtained using the above surface modification method.

A Still further embodiment of the invention provides a LCD device comprising a backlight module and any one of the above liquid crystal cell. The LCD device can be a display of a portable electronic device such as a portable PC, a mobile phone, and an E-book.

As the backlight module in the above embodiments has a component comprising the IR material and disposed therein, the backlight module can emit IR light having relatively strong penetration and radiation capabilities. When absorbed by the human body, the IR light may cause the in vivo water molecules to resonate, such that the water molecules are activated and the bonding force between the water molecules is increased. As a result, bio-macromolecules such as protein are activated and the bio-cells are in a higher vibrating energy level. As the bio-cells are resonating with each other, the far-IR thermal energy can be transferred to a deeper endermic location of the human body. The temperature at the deeper location therefore increases, and the generated heat is dissipated from inside toward outside, which will expand capillary vessels and facilitate blood circulation, thereby enhancing the metabolism between tissues, increasing regeneration capability of the tissues, and improving immune competence of the body. Such procedure is beneficial for the heath and can reduce the influence of electromagnetic radiation on the human body. Similarly, in the LCD device comprising the backlight module of the invention, the backlight module can emit IR light to the exterior of the LCD device, which makes the LCD device beneficial for the heath. Moreover, the surface modified IR material can realize compatibility and optimal performance matching with the corresponding component(s) of the backlight module, which will improve the heat exchange capability between the IR material and the backlight module as well the ambient light, and the surface modified IR material will emit far-IR light with higher emissivity.

What are described above is related to the illustrative embodiments of the disclosure only and not limitative to the scope of the disclosure; the scopes of the disclosure are defined by the accompanying claims.

1. A backlight module, wherein a component comprising an infrared (IR) material is disposed in the backlight module.

2. The backlight module of claim 1, wherein the component comprising the IR material is an IR layer made of the IR material.

3. The backlight module of claim 2, comprising a luminophor, a package for packaging the luminophor and a light guide plate disposed at one side of the package,
wherein the IR layer is disposed between the package and the light guide plate; and/or the IR layer is disposed on the light guide plate.

4. The backlight module of claim 3, further comprising a reflector sheet disposed below the luminophor, a diffuser sheet and a prism sheet both disposed above the light guide plate, the IR layer is disposed on one or two sides of at least one of the reflector sheet, the diffuser sheet and the prism sheet.

5. The backlight module of claim 2, comprising a brightness enhancement film, the IR layer is disposed on one or two sides of the brightness enhancement film.

6. The backlight module of claim 4, wherein the prism sheet comprises an upper prism sheet and a lower prism sheet, the IR layer is disposed on one or two sides of the upper and/or lower prism sheet.

7. The backlight module of claim 1, wherein the component comprising the IR material comprises at least one of the following components: a reflector sheet, a luminophor, a light guide plate, a diffuser sheet, a prism sheet, a brightness enhancement film, a package for the luminophor.

8. The backlight module of claim 7, wherein an IR layer made of the IR material is disposed on all or a part of the surface of one or two sides of at least one of the components.

9. The backlight module of claim 1, comprising a reflector sheet, a package for a luminophor, a light guide plate, a diffuser sheet, a prism sheet, a brightness enhancement film, at least one of which is made of a component comprising the IR material.

10. The backlight module of claim 1, wherein the IR material is a mixture of one or more of biochar, tourmaline, far-infrared ceramic, jade powder, aluminum oxide, copper(II) oxide, silver(I,III) oxide and silicon carbide.

11. The backlight module of claim 1, wherein a particle size of the IR material is in the order of a nanometer to a micrometer.

12. The backlight module of claim 1, wherein the IR material is surface modified so as to emit IR light when being irradiated.

13. A LCD device comprising the backlight module of claim 1.

14. A surface modification method for an IR material, comprising:
nanocrystallizing the IR material to obtain nanoparticles of the IR material;
modifying surface property of the nanocrystallized nanoparticles, such that the nanoparticles are compatible and have matching property with a corresponding component of a backlight module and emit IR light when being irradiated by light.

15. The method of claim 14, wherein nanocrystallizing the IR material comprises grinding and dispersing the IR material to obtain a dispersion solution of the IR material with an average particle size of 1 nm to 200 nm.

16. The method of claim 15, wherein modifying the surface property of the nanocrystallized nanoparticles comprises:
mixing the dispersion solution of the IR material with an organic solvent containing methyl methacrylate, styrene, maleimide, and then adding an azo-initiator solution into the mixture; and
after the reaction is finished, adding a cooling organic solvent to cool and stirring until resultant is cooled, then filtering and drying the resultant to obtain the surface modified IR material.

17. The method of claim 16, wherein the molar ratio between methyl methacrylate, styrene and maleimide is 1:1˜2:1˜2, the IR material weights 8˜25% of the total mixture weight; and the azo-initiator solution is added drop by drop with a weight of 1˜5% of total monomer weight.

18. The method of claim 16, wherein an environmental condition for modifying the surface property of the nanocrystallized nanoparticles has a temperature of 35° C.˜60° C. and in a nitrogen atmosphere;
a reaction time is 30 minutes to 90 minutes;
a temperature of the cooling organic solvent is 5° C. to 10° C.;
cooling is performed till room temperature;
filtering is performed for three times; and
drying is performed for 5 minutes to 20 minutes at 70° C. to 100° C.

19. (canceled)
